(19) United States
(12) Patent Application Publication
(10) Pub. No.: US 2011/0137896 A1
(43) Pub. Date: Jun. 9, 2011

(54) Information processing apparatus, predictive conversion method, and program

(75) Inventors: Shinya Masunaga, Tokyo (JP); Tomoaki Takemura, Tokyo (JP)

(73) Assignee: Sony Corporation, Tokyo (JP)

(21) Appl. No.: 12/927,431

(22) Filed: Nov. 15, 2010

(30) Foreign Application Priority Data
Dec. 7, 2009 (JP) P2009-277368

(51) Int. Cl. G06F 17/30

(52) U.S. Cl. 707/723; 707/769; 707/E17.039

(57) ABSTRACT

Provided is an information processing apparatus including an input portion, a metadata acquiring portion, a data forming portion, and a predictive converting portion. The input portion receives selection of content from a user. The metadata acquiring portion acquires metadata including a word indicative of information concerning the content whose selection was received by the input portion. The data forming portion extracts the word from the acquired metadata and forms predictive conversion data for each of the words. The predictive converting portion carries out predictive conversion of a word with respect to input data from the user using the formed predictive conversion data.

### BACKGROUND OF THE INVENTION

1. Field of the Invention

The present invention relates to an information processing apparatus, a predictive conversion method, and a program each having a function to output word data by predictive conversion with respect to key input data from a user.

2. Description of the Related Art

Especially in the case of a portable device such as a cellular phone among information processing apparatuses, it is difficult to provide a key input means having excellent operability due to spatial constraints. Hence, in the portable information processing apparatus, to reduce user's inputting labor, predictive conversion technique is widely employed. The predictive conversion is a system in which a computer predicts one or more words that a user intends to input, on the basis of data of one or more keys which are entered by the user, and the computer outputs a result of the prediction as predictive conversion candidates.

As methods of selecting a candidate in the predictive conversion, there are a method of using a previously prepared dictionary, a method of using input histories of a user, and a method of selectively using optimal dictionaries.

As a known example of the method of selectively using optimal dictionaries, Japanese Translation of PCT No. 2009-500954 (patent document 1) discloses a technique in which a terminal sends, to a server, an acquisition request of a dictionary including positional information of a user, and in reply to this request, the server produces a dictionary suitable for the positional information of the user and replies to the terminal. Also, Japanese Patent Application Laid-open No. 2008-305385 (patent document 2) discloses a technique in which dictionaries are automatically switched depending on kinds (kinds of fields) of data input by a user. According to these predictive conversion methods, since data that a user desires to input can effectively be narrowed down to some extent, there is an effect that inputting labor of the user can be reduced.

### SUMMARY OF THE INVENTION

However, according to the method of using a previously prepared dictionary and the method of using input histories of a user, candidates can be output only from general words which are originally registered in the dictionary or from words which were input in the past by a user. Therefore, it is not possible to output, as candidates, new words and buzz words such as titles of contents and new trade names which can frequently be found in the media such as television and movie but which are not frequently be used popularly.

According to the technique of the patent document 1, since words acquired by the predictive conversion are narrowed down only to information which relates to a user's position, uses are limited. Further, according to this technique, since a terminal downloads dictionary data from a server, there is a problem that it takes time before a user starts using this technique. On the other hand, according to the technique of the patent document 2, it is surely possible to excellently narrow down candidates of predictive conversion, but when dictionaries are switched depending on kinds of data, time lag is generated for the switching. In addition, in the techniques of any of the patent documents, new words and buzz words cannot be output as candidates.

In view of the above circumstances, it is desirable to provide an information processing apparatus, a predictive conversion method, and a program which can output new words and buzz words as candidates of predictive conversion, and which can output candidates which reflect user's preference.

According to an embodiment of the present invention, there is provided an information processing apparatus including: an input portion to receive selection of content from a user; a metadata acquiring portion to acquire metadata including a word indicative of information concerning the content whose selection was received by the input portion; a data forming portion to extract the word from the acquired metadata and form predictive conversion data for each of the word; and a predictive converting portion to carry out predictive conversion of a word with respect to input data from the user using the formed predictive conversion data.

According to the embodiment, the metadata acquiring portion acquires the metadata of the content selected by the user, the data forming portion extracts the word included in the metadata of the acquired content, and forms the predictive conversion data for each of the words, and the predictive converting portion carries out the predictive conversion of the word with respect to the input data from the user using the formed predictive conversion data. Therefore, it is possible to output words such as new words and buzz words extracted from the metadata of content as candidates of predictive conversion, i.e., it is possible to output new words and buzz words which reflect user's preference.

When a first word extracted from one metadata is a constituent element of a second word extracted from the metadata, the data forming portion may give alternate information to the predictive conversion data of the first word, and when the first word is determined as a first candidate as a result of the predictive conversion, the predictive converting portion may determine the second word as a second candidate as the result of the predictive conversion on the basis of the alternate information. According to this, the probability that a word desired by the user is output as the predictive conversion candidate is increased.

When a plurality of words are extracted from the one metadata, the data forming portion may give common attribute information to predictive conversion data sets of these words, and when one of the words is determined as the first candidate as a result of the predictive conversion, the predictive converting portion may determine the other word as the second candidate as the result of the predictive conversion on the basis of the attribute information. According to this configuration also, the probability that a word desired by the user is output as the predictive conversion candidate is increased.

The data forming portion may obtain a value of a weight with respect to a word extracted from the metadata on the basis of an extraction status, and form the predictive conversion data which further includes the value of the weight, the information processing apparatus may further include a storing portion capable of storing a plurality of the predictive conversion data sets formed by the data forming portion, and a normalization processing portion to carry out normalization processing while taking a degree of freshness in terms of time with respect to the value of the weight included in the predictive conversion data sets stored by the storing portion, and when a plurality of words are determined as candidates as a result of the predictive conversion, the predictive converting portion may prioritize words determined as candidates as the result of the predictive conversion on the basis of the value of the weight included in the predictive conversion data sets of these words. According to this configuration, the precision of predictive conversion is not deteriorated in the long term. In addition, if predictive conversion data sets are set to be deleted beginning with the chronologically oldest predictive conversion data, deterioration in the predictive conversion speed and the conversion precision caused by a bloated region where the predictive conversion data is stored can be suppressed.

The data forming portion may obtain the value of the weight on the basis of the number of appearance of the word from the metadata. According to this, a reasonable value of a weight can be obtained.

The information processing apparatus may further include: a content data acquiring portion to acquire actual data of the content; and a recognizing portion to recognize a word by at least one of image recognition and voice recognition from the actual data of the acquired content, and to provide the data forming portion with a result of this recognition as the metadata. According to this, it is possible to acquire predictive conversion data of various words which cannot be obtained from typical metadata.

A predictive conversion method based on another viewpoint of the present invention includes: receiving, by an input portion, selection of content from a user; acquiring, by a metadata acquiring portion, metadata including words indicative of information concerning the content whose selection was received by the input portion; extracting, by a data forming portion, the words from the acquired metadata, and forming predictive conversion data for each of the words; and carrying out, by a predictive converting portion, predictive conversion of a word with respect to input data from the user using the formed predictive conversion data.

A program based on another viewpoint of the present invention operates a computer: as an input portion to receive selection of content from a user; as a metadata acquiring portion to acquire metadata including words indicative of information concerning the content whose selection was received by the input portion; as a data forming portion to extract the words from the acquired metadata and form predictive conversion data for each of the words; and as a predictive converting portion to carry out predictive conversion of a word with respect to input data from the user using the formed predictive conversion data.

According to the present invention, it is possible to output words such as new words and buzz words extracted from metadata of contents as candidates of predictive conversion, that is, it is possible to output words such as new words and buzz words which reflect user's preference.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing an example of metadata which conforms to TV-Anytime;

FIG. 2 is a diagram showing a configuration of hardware of an information processing apparatus according to a first embodiment of the present invention;

FIG. 3 is a block diagram showing a functional configuration for carrying out predictive conversion in the information processing apparatus of the first embodiment;

FIG. 4 is a flowchart related to acquisition of metadata in the information processing apparatus of the first embodiment;

FIG. 5 is a diagram showing processing of a word extraction processing module in the information processing apparatus of the first embodiment;

FIG. 6 is an explanatory diagram of a configuration of predictive conversion data in the information processing apparatus of the first embodiment;

FIG. 7 is a diagram showing a renewal example of the predictive conversion data shown in FIG. 6;

FIG. 8 is a diagram showing a predictive conversion algorithm by an input conversion processing module in the information processing apparatus of the first embodiment; and

FIG. 9 is a block diagram showing a functional configuration for carrying out predictive conversion in an information processing apparatus of a second embodiment.

### DESCRIPTION OF PREFERRED EMBODIMENTS

Hereinafter, embodiments of the present invention will be described with reference to the drawings.

The embodiments will be described in the following order.

1. General outlines of first embodiment

2. Concerning metadata

3. Information processing apparatus according to first embodiment

4. Acquisition of metadata

5. Formation of predictive conversion data from metadata

6. Predictive conversion

7. Acquisition of metadata from image and voice data

8. Effect of first embodiment

9. Second embodiment

10. Other modifications

### 1. General Outlines of First Embodiment

The first embodiment relates to an information processing apparatus having a predictive conversion function to determine, as candidates, one or more word data sets by predictive conversion with respect to a key entered by a user, to prioritize the candidates, and to output the same. Examples of the information processing apparatus having the predictive conversion function are a cellular phone, a Personal Digital Assistant (PDA), a game machine, a portable personal computer, and a portable medium player, but the present invention is not limited to them.

The information processing apparatus of this embodiment can receive digital data of content through a network or broadcast wave, and can carry out at least one of playing and recording. To determine contents to be played or recorded, the user of the information processing apparatus acquires, from a server, metadata of content selected by the user, and the user can see a description of the content on a display screen if necessary. The information processing apparatus analyzes the acquired metadata, extracts a word showing information concerning the content such as a title of the content from the metadata, forms predictive conversion data of the word, and saves the data. If a key input by the user occurs, the information processing apparatus executes the predictive conversion using the predictive conversion data, shows one or more word data sets which are predictive conversion candidates to allow the user to select one of them, and determines the selected word data as input data from the user.

### 2. Concerning Metadata

The metadata of content is data which is formed so that even if the content is not actually played, the user can know information concerning the content such as a title, details, a rough outline, a genre and performers. Time to acquire metadata of content depends on delivery service of the content. For example, metadata of content may be acquired when content that the user desires to acquire is determined by the user, or when the content is actually being transferred.

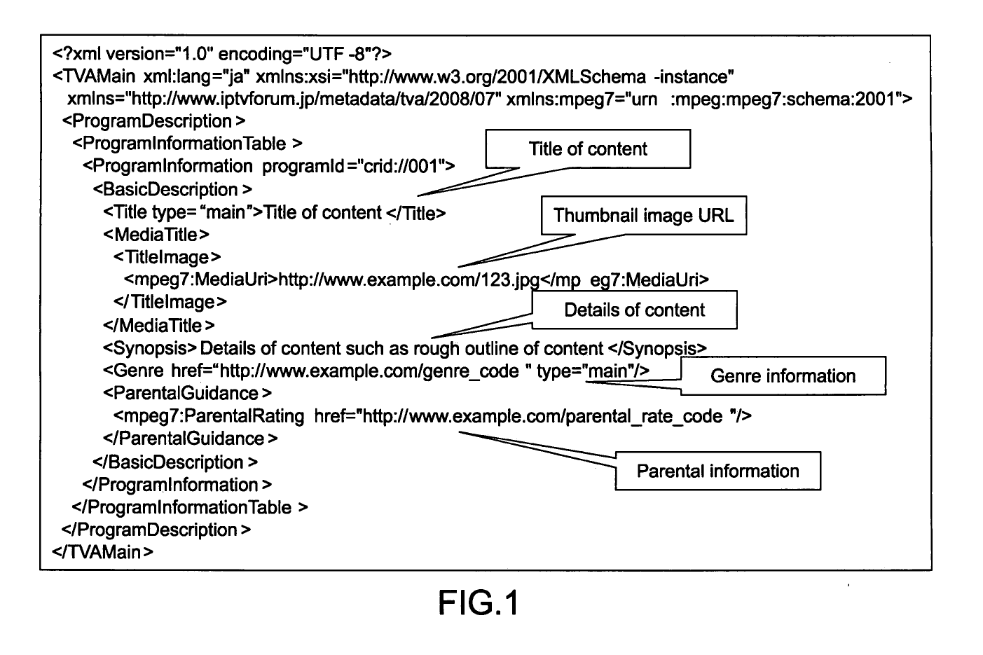

FIG. 1 shows an example of metadata which conforms to TV-Anytime. The TV-Anytime metadata is a standard of metadata standardized by European Telecommunications Standards Institute (ETSI). For example, TV-Anytime metadata becomes a candidate of a metadata format of Internet Protocol Television (IPTV) standard in Digital Video Broadcasting (DVB) or IPTV standard in ITU-T. In the TV-Anytime, TV-Anytime metadata is used as information desired for storing acquired contents and for retrieving so that the user can view a desired content when the user desires to do so.

As shown in FIG. 1, TV-Anytime metadata includes words such as a title of content, thumbnail image URL, details of content, genre information and parental information. Each of the words is described as a value of a determined element. In some cases, details of content also include information such as a rough outline of the content, performers, a creator (author, writer) and a maker.

The metadata of this embodiment is not limited to the TV-Anytime metadata. For example, in YouTube known as a video content-sharing website which is run by YouTube, LLC, there is metadata defined by YouTube data API, and this can be employed in this embodiment.

### 3. Information Processing Apparatus According to First Embodiment

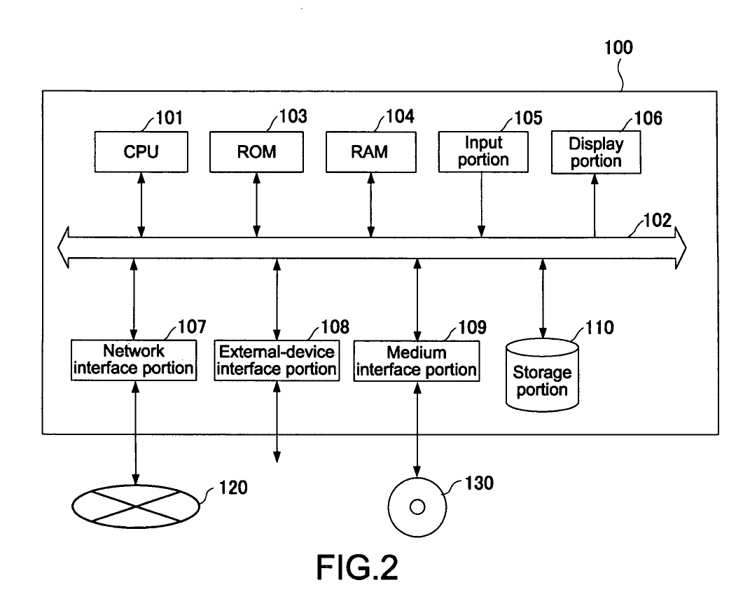

FIG. 2 is a diagram showing a configuration of hardware of an information processing apparatus 100 according to the first embodiment.

As shown in FIG. 2, the information processing apparatus 100 has a configuration of a typical computer. That is, connected to a Central Processing Unit (CPU) 101 through a system bus 102 are at least a Read Only Memory (ROM) 103, a Random Access Memory (RAM) 104, an input portion 105, a display portion 106, a network interface portion 107, an external-device interface portion 108, a medium interface portion 109 and a storage portion 110.

The input portion 105 includes a plurality of keys, and processes inputs of instructions and data from the user. The instructions and data which are input by the user through the input portion 105 are sent to the CPU 101 via the system bus 102. The display portion 106 is constituted buy a display device such as a Liquid Crystal Display (LCD).

The network interface portion 107 processes connection with a network 120 such as the Internet through a wire or in a wireless manner. The external-device interface portion 108 is a Universal Serial Bus (USB) interface for example, and this is used for transferring data and a program to and from various kinds of external devices. Various kinds of media (storage medium) 130 such as a magnetic disk, an optical disk, and a flash memory can be attached to and detached from the medium interface portion 109. Information can be read from and written into the attached medium 130.

The storage portion 110 includes a nonvolatile storage device such as a hard disk drive and a semiconductor memory, and various data and programs can be stored therein. Examples of the program are an operating system and an application program for operating the computer as the information processing apparatus 100. These programs may be stored in the ROM 103.

The CPU 101 loads a program from the ROM 103 or the storage portion 110 to the RAM 104, and carries out computation for interpretation and execution of the program. The RAM 104 is a main memory into which a program loaded from the ROM 103 or the storage portion 110 or operation data of the program is written.

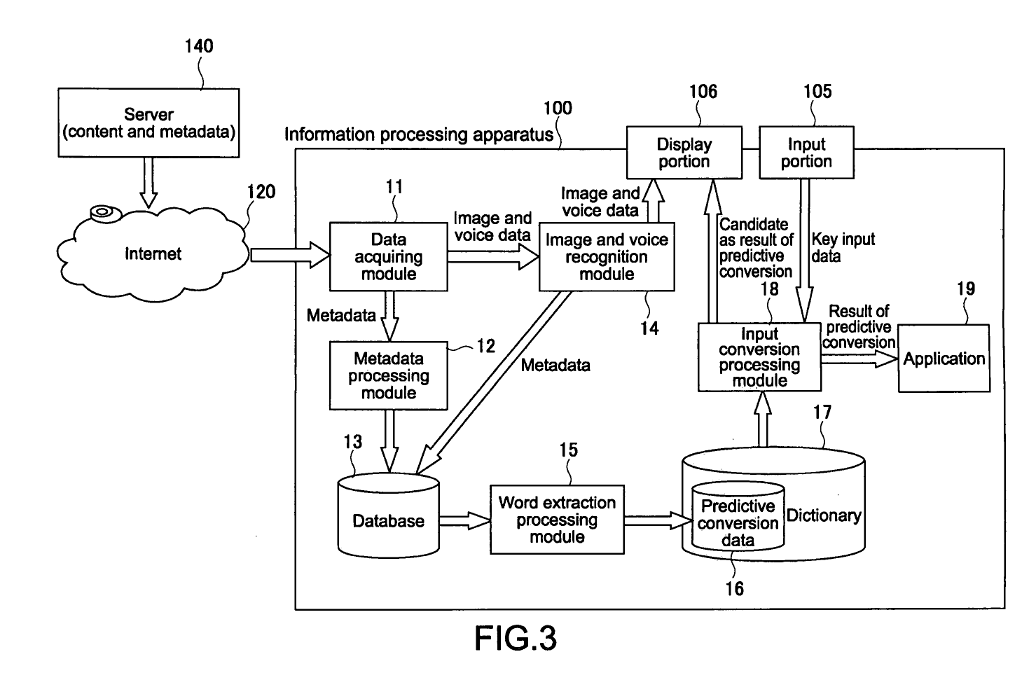

FIG. 3 is a block diagram showing a functional configuration (program configuration) for producing predictive conversion data on the basis of metadata in the information processing apparatus 100 shown in FIG. 2, and for carrying out predictive conversion with respect to key input data from the user using the predictive conversion data. The key input data is input data corresponding to a key which is operated in a keyboard or its input data string.

As shown in FIG. 3, as functional constituent elements, the information processing apparatus 100 includes a data acquiring module 11 (metadata acquiring portion, a contents data acquiring portion), a metadata processing module (metadata acquiring portion), a database 13, an image and voice recognition module 14 (recognizing portion), a word extraction processing module 15 (data forming portion) and an input conversion processing module 18 (predictive converting portion).

In FIG. 3, the data acquiring module 11 is a module to acquire content and metadata through the Internet 120 from a server 140 which delivers content and metadata of the content. To acquire metadata of content, the data acquiring module 11 receives identifying information of content selected by the user using the input portion 105, and produces an acquisition request of metadata of the content on the basis of identifying information of the content, and sends the acquisition request to the server 140. The module is a portion which performs a specific function in a program.

The metadata processing module 12 stores metadata acquired by the data acquiring module 11 in the database 13.

The database 13 is constructed in a storage region of any of the storage portion 110, the RAM 104, and the medium 130, and metadata is stored in the database 13. Physically, the database 13 can be constructed in the storage portion 110.

The image and voice recognition module 14 recognizes word data from an image and a sound included in content acquired by the data acquiring module 11, and stores the recognized word data in the database 13 as data corresponding to metadata. Since word data such as a title of content is included in the content as an image or a sound in many cases, the image and voice recognition module 14 recognizes the word data and stores the same in the database 13 as metadata.

The word extraction processing module 15 takes out a value of an element of a specific name from metadata stored in the database 13, performs the morpheme analysis if necessary, extracts a word (including a discrete word) in the element, forms predictive conversion data 16 for each word, and registers the predictive conversion data 16 in a dictionary 17 (storing portion) in a form of a table. Physically, the dictionary 17 can be constructed in the storage portion 110.

The input conversion processing module 18 receives data which was input by the user using the keys through the input portion 105, carries out the predictive conversion using the predictive conversion data 16 in the dictionary 17, and outputs one or more word data sets corresponding to the key input data to the display portion 106 as predictive conversion candidates. As a result of the predictive conversion, the input conversion processing module 18 supplies, to an application 19, one word data selected by the user using the input portion 105 from one or more predictive conversion candidates displayed on the display portion 106.

The application 19 is a program for carrying out a predetermined operation using word data supplied from the input conversion processing module 18.

Next, operation of the information processing apparatus 100 of this embodiment will be described.

### 4. Acquisition of Metadata

First, operation for acquiring metadata will be described.

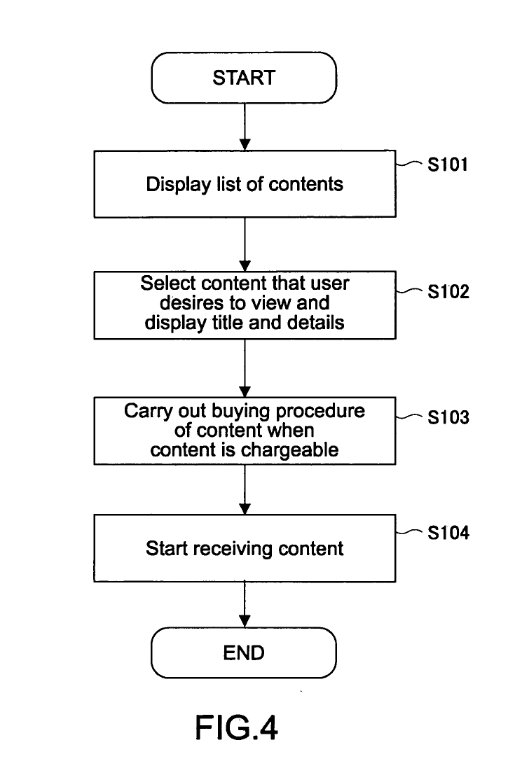

FIG. 4 is a flowchart concerning acquisition of metadata.

First, the data acquiring module 11 acquires a list including acquirable contents from the server 140 or the like shown in FIG. 3 through the Internet 120 using Hyper Text Markup Language (HTML) browser or Electric Content Guide (ECG), and displays the list on the display portion 106 (step S101). A sender of the list of contents need not be the server 140 shown in FIG. 2.

If content that the user desires to view is selected from the displayed list of contents using the input portion 105, the data acquiring module 11 acquires information such as a title and details of the content and displays the same on the display portion 106 (step S102). Here, the information such as the title and the details of the content may be information embedded in the list of contents, or may be information newly acquired from outside through the Internet 120. The information such as the title and the details of the content is acquired by the data acquiring module 11 as metadata depending on kinds of delivery service of contents (such as YouTube).

When content that the user desires to view is chargeable, a buying procedure of the content is carried out through the Internet 120 (step S103).

Next, if the data acquiring module 11 receives an acquisition request of content from the user through the input portion 105, the data acquiring module 11 sends a content acquisition request to the server 140 shown in FIG. 3, and starts receiving the content from the server 140 by a streaming method or a download method (step S104). When TV-Anytime metadata is to be acquired, the TV-Anytime metadata is also delivered from the server 140 at the time of the streaming or the downloading of the content, and this metadata is acquired by the data acquiring module 11.

Although the two kinds of methods for acquiring metadata are described above, the acquiring method and the acquiring timing of metadata are not limited to them. For example, also when free content is to be acquired, the TV-Anytime metadata is delivered in some cases. Further, metadata is included in a list itself of contents in some cases. In such a case, metadata can be acquired by analyzing a description in the list.

Metadata acquired by the data acquiring module 11 in this manner is stored in the database 13 by the metadata processing module 12.

### 5. Formation of Predictive Conversion Data 16 from Metadata

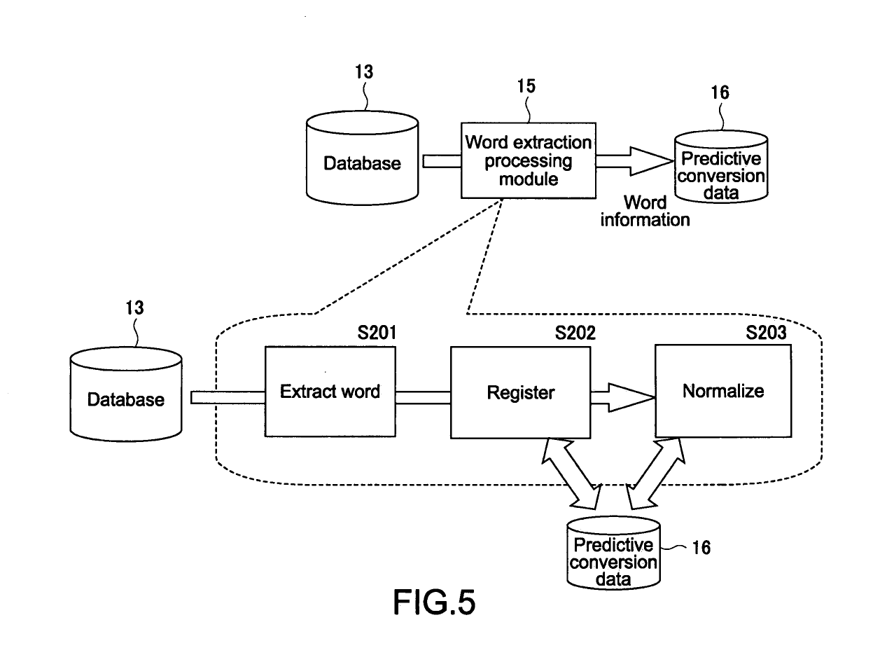

Next, operation of the word extraction processing module 15 for forming the predictive conversion data 16 from metadata stored in the database 13 will be described. FIG. 5 is a diagram showing processing carried out by the word extraction processing module 15.

First, the word extraction processing module 15 takes out a value of an element of a specific name from metadata stored in the database 13, performs the morpheme analysis if necessary, extracts a word (a part of speech) in the element (FIG. 5: step S201), determines extracted discrete words and a connected portion of a plurality of discrete words as words, forms the predictive conversion data 16 for each word, and registers the predictive conversion data 16 in the dictionary 17 in a form of a table (FIG. 5: step S202).

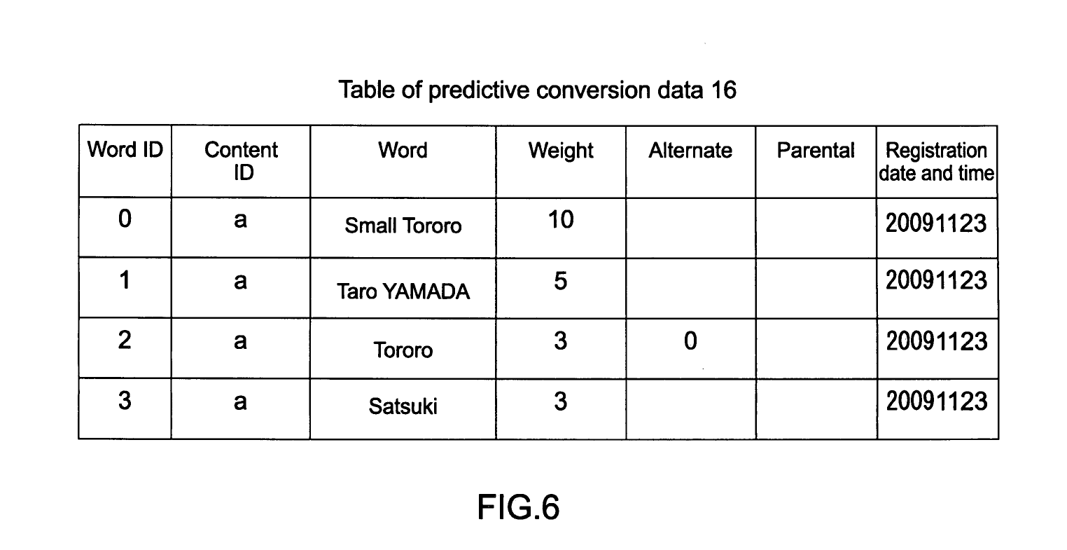

FIG. 6 is an explanatory diagram of a configuration of the predictive conversion data 16. As an example, words “small Tororo”, “Taro YAMADA”, “Tororo” and “Satsuki” are extracted from metadata of content having a title “small Tororo”, and predictive conversion data 16 of each word is shown.

As show in FIG. 6, the predictive conversion data 16 includes a word ID, a content ID, a word, a weight, alternate, parental, and registration date and time. The predictive conversion data 16 is stored in a form of a table. Predictive conversion data 16 for a new word is newly registered sequentially in the table.

In the configuration of the predictive conversion data 16, the word ID is uniquely given to each word by the word extraction processing module 15.

The content ID (attribute information) is uniquely given to content corresponding to metadata from which that word was extracted. The content ID may be allocated by the metadata processing module 12, or may be allocated by a service provider.

A word in the configuration of the predictive conversion data 16 is actual data of a word extracted from metadata by the word extraction processing module 15.

The weight in the configuration of the predictive conversion data 16 is a value calculated using a predetermined calculation equation on the basis of the number of appearance of the same word in one metadata, the appearing place (such as a title, details and genre), and the number of actually viewed times of the content. The weight is used by the input conversion processing module 18 as information for determining a rank order of predictive conversion candidates.

The alternate is information indicating that, in a plurality of words extracted from one metadata, a word in a predictive conversion data 16 is a constituent element of a word in another predictive conversion data 16. A value of the alternate is a word ID in another predictive conversion data 16. That is, when a first word extracted from one metadata is a constituent element of a second word extracted from the same metadata, the word extraction processing module 15 gives a value of the alternate to predictive conversion data 16 of the first word. In the example in FIG. 6, since the word “Tororo” is a constituent element of the word “small Tororo”, a word ID (=0) of the word “small Tororo” is registered as a value of the alternate in the predictive conversion data 16 of the word “Tororo”.

The parental is information for parental lock. The word extraction processing module 15 determines whether a word should be a subject of the parental lock in accordance with previously defined parental conditions, and sets a value for the parental lock for the word which should be the subject of the parental lock. The input conversion processing module 18 treats a word in which a value for the parental lock is set as a word in which the user is limited.

Registered date and time are date and time (year, month, and day) when the predictive conversion data 16 of a word is registered.

If predictive conversion data 16 of a word extracted from new metadata is added and the table is renewed, the word extraction processing module 15 carries out the following normalization processing for the entire table while taking into consideration the degree of freshness in terms of time of the predictive conversion data 16 (FIG. 5: step S203).

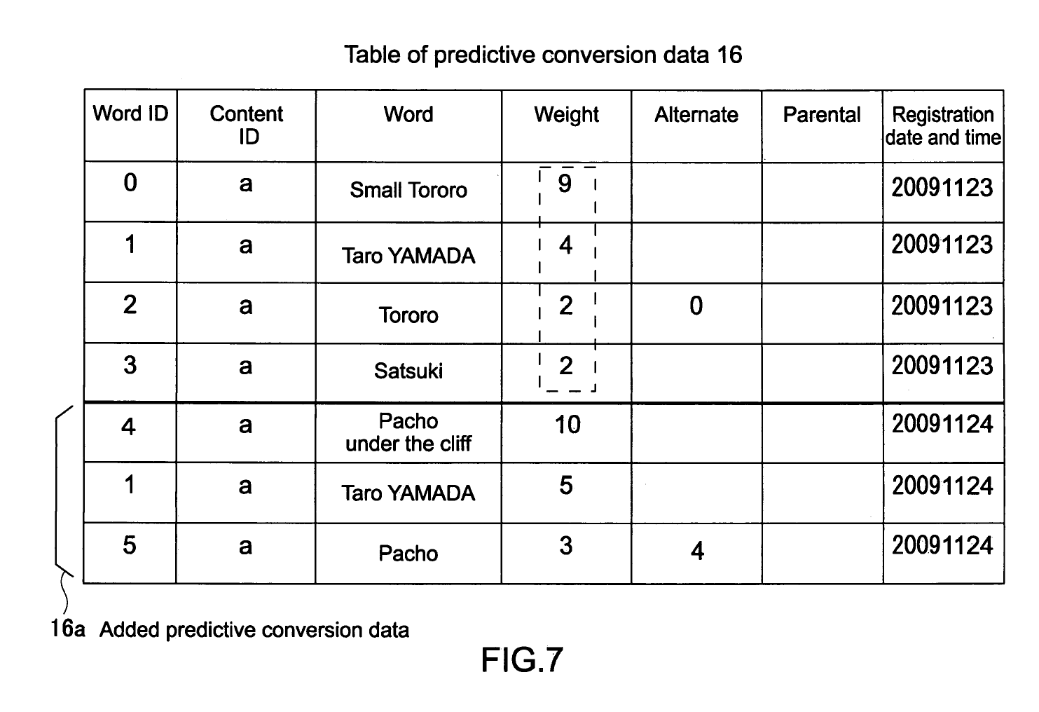

FIG. 7 shows an example of renewal of a table which is necessitated by addition of predictive conversion data 16a of a word extracted from new metadata. Here, FIG. 7 shows an example in which words “Pacho under the cliff”, “Taro YAMADA” and “Pacho” are extracted from metadata of content having a title “Pacho under the cliff”, and predictive conversion data 16a of these words is added.

In this example, trigger conditions of normalization processing of the table are set such that “when predictive conversion data of new date is added, the normalization processing should be executed”. The predictive conversion data 16a of a word extracted from metadata of content having the title “Pacho under the cliff” is added to the table on Nov. 24, 2009. In the example shown in FIG. 7, since the registered date and time of the predictive conversion data 16 which existed before that date is Nov. 23, 2009, the word extraction processing module 15 lowers the value of the weight of these existing predictive conversion data 16. In the example shown in FIG. 7, values of weights of predictive conversion data 16 are lowered by “1” uniformly. This lowering value may freely be set by the user. By lowering the value of the weight of old predictive conversion data 16 as described above, a degree of freshness of the predictive conversion data 16 can be reflected to the predictive conversion carried out by the input conversion processing module 18.

The trigger conditions of the normalization processing may freely be set by the user. For example, when predictive conversion data is newly added irrespective of date, the normalization processing may be executed. The value of the weight of existing predictive conversion data may be lowered on the basis of elapsed time from the registered date and time whether or not new predictive conversion data is added and eventually, that predictive conversion data may be deleted.

In the table shown in FIG. 7, predictive conversion data of the word “Taro YAMADA” is registered twice at different timings. When predictive conversion data of the same word as that already registered in the table is again registered, the word extraction processing module 15 allocates the word ID of the existing word as a word ID of a word which is newly registered. The reason why the predictive conversion data of the same word is separately registered in the table is that since the number of appearance and appearing places are different in respective metadata, there is a possibility that values of weights become different from each other. The input conversion processing module 18 regards a plurality of predictive conversion data sets to which the same word ID is allocated as predictive conversion data of one word, and regards a total of the values of the weights as a value of a weight of that word. With this configuration, it can be expected that the precision of predictive conversion is enhanced.

### 6. Predictive Conversion

Next, predictive conversion using the predictive conversion data 16 will be described.

The input conversion processing module 18 outputs one or more word data sets as predictive conversion candidates using the predictive conversion data 16 on a table with respect to key input data from the user. At that time, the input conversion processing module 18 calculates priorities with respect to the word data sets which are respective predictive conversion candidates, and outputs the respective word data sets to which priority information sets based on the priorities are added.

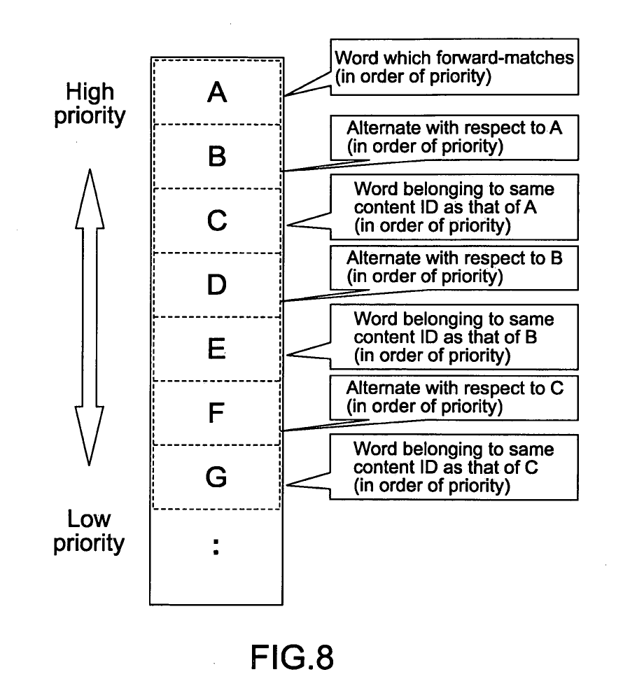

FIG. 8 is a diagram showing a predictive conversion algorithm carried out by the input conversion processing module 18. The input conversion processing module 18 carries out predictive conversion in accordance with this algorithm as follows. In FIG. 8, A, B, C, D, E, F, G, . . . show different words registered in the table.

First, the input conversion processing module 18 retrieves a word (A) which forward-matches between key input data sets from the user and words registered in the table, and outputs this word (A) as a predictive conversion candidate having the highest priority. If a plurality of words (A) (A′) are found, the input conversion processing module 18 determines rank orders of the words (A) (A′) on the basis of values of their weights, and outputs the words (A) (A′) as a plurality of predictive conversion candidates having rank orders.

Next, if a word (B) having an alternate relation with respect to the word (A) exists, the input conversion processing module 18 outputs the word (B) as a predictive conversion candidate having the next highest priority. If a plurality of words (B) (B′) are found, the input conversion processing module 18 determines rank orders of the words (B) (B′) on the basis of values of their weights, and outputs the words (B) (B′) as a plurality of predictive conversion candidates having rank orders. If a plurality of words (A) (A′) exist, the input conversion processing module 18 retrieves a word (B″) having an alternate relation with respect to the word (A′) having the next highest rank order, and repeats the same processing.

Next, if a word (C) belonging to the same content ID as that of the word (A) exists, the input conversion processing module 18 outputs the word (C) as a predictive conversion candidate having the next highest priority. If a plurality of words (C) (C′) are found, the input conversion processing module 18 determines rank orders of the words (C) (C′) on the basis of values of their weights, and outputs the words (C) (C′) as a plurality of predictive conversion candidates having rank orders. If a plurality of words (A) (A′) exist, the input conversion processing module 18 retrieves a word (C″) belonging to the same content ID as that of the word (A′) having the next highest rank order, and repeats the same processing.

Next, when a word (D) having an alternate relation with respect to the word (B) exists, the input conversion processing module 18 outputs the word (D) as a predictive conversion candidate having the next highest priority. When a plurality of words (D) (D′) are found or when a plurality of words (B) (B′) exist, the same operation as that described above should be carried out.

Next, when another word (E) belonging to the same content ID as that of the word (B) exists, the input conversion processing module 18 outputs the word (E) as a predictive conversion candidate having the next highest priority. When a plurality of words (E) (E′) are found or when a plurality of words (B) (B′) exist, the same operation as that described above should be carried out.

Next, when a word (F) (word (F) including the word (C) as the constituent element) having an alternate relation with respect to the word (C) exists, the input conversion processing module 18 outputs the word (F) as a predictive conversion candidate having the next highest priority. When a plurality of words (F) (F′) are found or when a plurality of words (C) (C′) exist, the same operation as that described above should be carried out.

Thereafter, if another word (G) belonging to the same content ID as that of the word (C) exists, the input conversion processing module 18 outputs the word (G) as a predictive conversion candidate having the next highest priority. When a plurality of words (G) (G′) are found or when a plurality of words (C) (C′) exist, the same operation as that described above should be carried out.

Next, assuming that the table of the predictive conversion data 16 shown in FIG. 7 is already formed, a specific example of the predictive conversion based on the algorithm will be described.

When key input data “Pacho” is input by the user, and the input conversion processing module 18 recognizes this, the input conversion processing module 18 outputs, as predictive conversion candidates, words “Pacho”, “Pacho under the cliff”, “Taro YAMADA”, “small Tororo”, “Tororo” and “Satsuki” in decreasing order of the priority by predictive conversion based on the algorithm.

When key input data “YAMADA” is input by the user, the input conversion processing module 18 outputs, as predictive conversion candidates, words “Taro YAMADA”, “Pacho under the cliff”, “small Tororo”, “Pacho”, “Tororo” and “Satsuki” in decreasing order of the priority.

As described above, according to this embodiment, if a word is determined as a predictive conversion candidate and if there is another word having the former word as a constituent element, this another word can also be output as a predictive conversion candidate, or a word which was extracted from metadata of the same content as that of a word which was determined as a predictive conversion candidate can also be output as a predictive conversion candidate. According to this, a probability that a word desired by the user is output as a predictive conversion candidate is further increased.

### 7. Acquisition of Metadata from Image and Voice Data

The information processing apparatus 100 of this embodiment can acquire data corresponding to metadata from image and voice data which is substantive data of content acquired from the server 140, and can store the same in the database 13.

That is, when the data acquiring module 11 acquires image and voice data of content, the image and voice recognition module 14 recognizes characters such as a title, performers and subtitles from a frame image of the content, and stores a result of the recognition in the database 13 as metadata. Since information such as a title and performers is included also in sound data of content in many cases, the image and voice recognition module 14 recognizes the information from the sound data of the content, and stores the information in the database 13 as metadata.

The word extraction processing module 15 extracts words by performing the morpheme analysis if necessary from metadata acquired by image recognition or sound recognition, and registers the words in the table as the predictive conversion data 16. Other operation is the same as that described above.

Since metadata is extracted by the image recognition and sound recognition from the image and voice data of content and the metadata is registered in the database 13, predictive conversion data of various words which cannot be acquired from typical metadata can be acquired.

### 8. Effect of the Embodiment

As described above, according to this embodiment, the predictive conversion data 16 of words extracted from metadata of content selected by the user is formed to be used for predictive conversion. In this manner, words extracted from metadata of the content, i.e., words such as new words and buzz words which reflect user's preference can be output as predictive conversion candidates. This embodiment also has a merit that it is unnecessary to carry out an intended operation such as registration of data from the user.

According to this embodiment, since the normalization processing for correcting a value of a weight based on a degree of freshness of the predictive conversion data 16 is carried out, the precision of predictive conversion is not deteriorated in the long term. In addition, if predictive conversion data sets 16 set to be deleted beginning with the chronologically oldest predictive conversion data, deterioration in the predictive conversion speed and the conversion precision caused by a bloated table of the predictive conversion data 16 can be suppressed.

According to this embodiment, another word extracted from the same metadata as that of a word which was determined by the forward-matching with respect to key input data from the user is also output as a predictive conversion candidate, even if the user forgets a target word, if the user inputs some related word, there is a possibility that the target word can be selected from predictive conversion candidates.

### 9. Second Embodiment

Next, a second embodiment of the present invention will be described.

In the first embodiment, the database 13 in which metadata is stored is provided in the information processing apparatus, and a word is extracted from the metadata stored in the database 13 and the predictive conversion data 16 is formed. However, in the second embodiment, the database 13 is not always necessary.

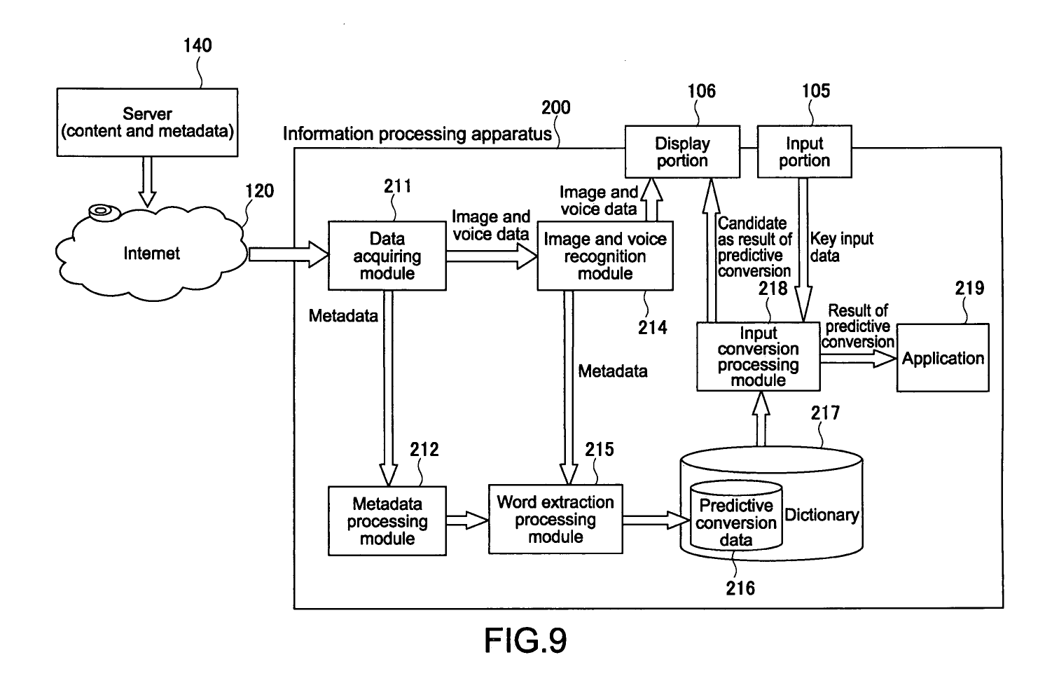

FIG. 9 is a block diagram showing a functional configuration for predictive conversion of an information processing apparatus 200 of the second embodiment. In FIG. 9, blocks which are the same as those of the information processing apparatus 100 of the first embodiment shown in FIG. 3 are designated with corresponding numbers in the 200s. Here, only points different from the information processing apparatus 100 of the first embodiment will be described.

Information processing apparatus 200 of the second embodiment is different from the information processing apparatus 100 of the first embodiment in that a metadata processing module 212 delivers metadata acquired by a data acquiring module 211 directly to a word extraction processing module 215 and makes the word extraction processing module 215 form the predictive conversion data 216. The image and voice recognition module 214 also delivers character data such as a title and performers recognized from image and voice data of content acquired from the server 140 directly to the word extraction processing module 215 to make the word extraction processing module 215 form the predictive conversion data 216. According to this, the information processing apparatus 200 which does not have a relatively large capacity storage portion can carry out the same predictive conversion as that of the information processing apparatus 100 of the first embodiment.

### 10. Other Modifications

A case where information (URL: Uniform Resource Locator) showing an address of a thumbnail image is included in metadata as shown in FIG. 1 will be considered. In this case, in the information processing apparatus 100 of the first embodiment, the word extraction processing module 15 may recognize the information showing the address as one word, and may register predictive conversion data 16 of that word in the table. According to this, when the user desires to see a thumbnail image, if the user inputs a title of the content for example, the user can obtain information showing the address as a predictive conversion candidate, and user's labor for searching information showing the address of the thumbnail image is reduced.

It is also possible to employ such a configuration that whenever a word is registered in the table, the word extraction processing module 15 manages the number of times when a user selects a predictive conversion candidate, and a word having the number of times which exceeds a predetermined value is registered in the user dictionary used in a conversion mode other than predictive conversion.

The present invention is not limited to the above-described embodiments only, and it is of course possible to variously modify the present invention within a range not departing from the gist of the present invention.

The present application contains subject matter related to that disclosed in Japanese Priority Patent Application JP 2009-277368 filed in the Japan Patent Office on Dec. 7, 2009, the entire contents of which is hereby incorporated by reference.

It should be understood by those skilled in the art that various modifications, combinations, sub-combinations and alternations may occur depending on design requirements and other factors insofar as they are within the scope of the appended claims or the equivalents thereof.

What is claimed is:

1. An information processing apparatus comprising:
an input portion to receive selection of content from a user;
a metadata acquiring portion to acquire metadata including a word indicative of information concerning the content whose selection was received by the input portion;
a data forming portion to extract the word from the acquired metadata and form predictive conversion data for each of the words; and
a predictive converting portion to carry out predictive conversion of a word with respect to input data from the user using the formed predictive conversion data.

2. The information processing apparatus according to claim 1,
wherein when a first word extracted from one metadata is a constituent element of a second word extracted from the metadata, the data forming portion gives alternate information to the predictive conversion data of the first word, and
wherein when the first word is determined as a first candidate as a result of the predictive conversion, the predictive converting portion determines the second word as a second candidate as the result of the predictive conversion on the basis of the alternate information.

3. The information processing apparatus according to claim 2,
wherein when a plurality of words are extracted from the one metadata, the data forming portion gives common attribute information to predictive conversion data sets of these words, and
wherein when one of the words is determined as the first candidate as a result of the predictive conversion, the predictive converting portion determines the other word as the second candidate as the result of the predictive conversion on the basis of the attribute information.

4. The information processing apparatus according to claim 3,
wherein the data forming portion obtains a value of a weight with respect to a word extracted from the metadata on the basis of an extraction status, and forms the predictive conversion data which further includes the value of the weight,
wherein the information processing apparatus further comprises:
a storing portion capable of storing a plurality of the predictive conversion data sets formed by the data forming portion; and
a normalization processing portion to carry out normalization processing while taking a degree of freshness in terms of time with respect to the value of the weight included in the predictive conversion data sets stored by the storing portion, and
wherein when a plurality of words are determined as candidates as a result of the predictive conversion, the predictive converting portion prioritizes words determined as candidates as the result of the predictive conversion on the basis of the value of the weight included in the predictive conversion data sets of these words.

5. The information processing apparatus according to claim 4, wherein the data forming portion obtains the value of the weight on the basis of the number of appearance of the word from the metadata.

6. The information processing apparatus according to claim 5, further comprising:
a content data acquiring portion to acquire actual data of the content; and
a recognizing portion to recognize a word by at least one of image recognition and voice recognition from the actual data of the acquired content, and to provide the data forming portion with a result of this recognition as the metadata.

7. The information processing apparatus according to claim 6, wherein the metadata acquiring portion acquires the metadata through a network.

8. A predictive conversion method comprising:
receiving, by an input portion, selection of content from a user;
acquiring, by a metadata acquiring portion, metadata including words indicative of information concerning the content whose selection was received by the input portion;
extracting, by a data forming portion, the words from the acquired metadata, and forming predictive conversion data for each of the words; and
carrying out, by a predictive converting portion, predictive conversion of a word with respect to input data from the user using the formed predictive conversion data.

9. A program operating a computer:
as an input portion to receive selection of content from a user;
as a metadata acquiring portion to acquire metadata including words indicative of information concerning the content whose selection was received by the input portion;
as a data forming portion to extract the words from the acquired metadata and form predictive conversion data for each of the words; and
as a predictive converting portion to carry out predictive conversion of a word with respect to input data from the user using the formed predictive conversion data.
